(19) United States
(12) Patent Application Publication
(10) Pub. No.: US 2007/0093598 A1
(43) Pub. Date: Apr. 26, 2007

(54) Wax copolymers and their application

(75) Inventor: Franz-Leo Heinrichs, Sulzbach (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant Produkte (Deutschland) GmbH

(21) Appl. No.: 11/586,376

(22) Filed: Oct. 25, 2006

(30) Foreign Application Priority Data
Oct. 25, 2005 (DE) 10 2005 050996.7

(51) Int. Cl. C08G 73/02

(52) U.S. Cl. 524/800

(57) ABSTRACT

A copolymer of at least two monomers selected from the group containing: A acrylic esters/methacrylic esters, B ethylenically unsaturated acids such as acrylic acid, methacrylic acid, itaconic acid, C styrene or styrene derivatives, D di- and trifunctional ethylenically unsaturated compounds such as divinylbenzene, glycol diacrylate, TMP triacrylate, E vinyl ethers, F polymerizable waxes contains component F in an amount of at least 1% by weight and is suitable for coating paper, wood, seed or floors, as a binder in printing inks, for autocare, as a matting agent in varnishes, or as a toner wax.

The present invention is described in the German priority application No. 10 2005 050 996.7, filed 25 Oct. 2005, which is hereby incorporated by reference as is fully disclosed herein.

The invention relates to copolymers of ethylenically unsaturated carboxylic acids, derivatives thereof, styrene or styrene derivatives, and free-radically polymerizable waxes by means of free-radically initiated polymerization and to the use of these products as they are or as dispersions for producing hydrophobic films in application segments such as leathercare products, floorcare products, autocare products, wood varnishes, inks, including printing inks, toners, textile processing, papermaking and paper processing, and adhesives production.

Wax copolymers can be prepared via free-radical polymerization at high pressure from ethylene and suitable comonomers in bulk, in solvents, or in emulsion polymerization.

Compared with other chemical processes, the preparation of emulsion polymers is relatively simple and much described. In one step the polymer is prepared, after which volatile compounds are separated off, followed by removal of coarse fractions, and then the polymer can be used. This may take place either after workup as a dry substance or after corresponding formulation as a dispersion. Batch, semibatch or continuous processes can be employed for this. The general chemical properties are determined by the chemistry of the monomers, the crystallinity of the polymer, the glass transition temperature T_{g}, and the molar weight. The performance of the polymer is determined by the choice of monomers or monomer combinations employed. For instance, vinyl chloride imparts flame retardation, acrylates have good thermal stability and weathering stability, and acrylonitrile provides good solvent resistance.

Base Monomers for Emulsion Polymerization

| Monomer | T_{g} ° C. |
|---|---|
| 1,4-Butadiene | −85 |
| n-Butyl acrylate | −54 |
| 2-Ethylhexyl acrylate | −50 |
| Methyl acrylate | 10 |
| Vinyl acetate | 32 |
| Vinyl chloride | 81 |
| Acrylonitrile | 97 |
| Methyl methacrylate | 100 |
| Styrene | 105 |

To introduce certain properties, suitable monomers are combined with one another. For instance, there are known monomers or monomer combinations for achieving the properties specified below:

Assignment of Monomers to Polymer Properties

| Property | preferred monomer or monomer combination |
|---|---|
| Stiffness | methyl acrylate, acrylonitrile, styrene |
| Softness | n-butyl acrylate, ethyl acrylate, butadiene |
| Tack | 2-ethylhexyl acrylate, hexyl acrylate |
| Water resistance | hydrophobic monomers, butyl acrylate, crosslinks |
| Solvent resistance | acrylonitrile, crosslinking |
| Tensile strength | high T_{g}, styrene, MMA, acrylonitrile |
| Extension | low T_{g}, butyl acrylate, styrene |
| Thermoplastic | no crosslinking |
| properties | |
| Swelling behavior | acrylic acid |

High fractions of water-soluble monomers such as acrylic acid, methacrylic acid, itaconic acid, fumaric acid, hydroxyethyl acrylate, and acrylamide lead likewise to particular effects.

A high fraction of acrylic acid brings about an accumulation of charge at the particle surface, which leads to thickening at high pH; however, the accumulation of charge also contributes to an increase in the mechanical load-bearing capacity of the dispersions. Monomers of this kind are likewise able to enhance the stability toward electrolytes or additions of salt.

Surfactants used are anionic or nonionic surfactants, usually in the form of combinations.

Initiators which can be used include both organic and inorganic free-radical initiators, usually peroxides or peroxo salts.

The molar weight is controlled using regulators: substances which intervene as free-radical scavengers in chain growth.

In many applications it is common to combine the polymer dispersions with wax dispersions or dispersions of ground waxes in order to tailor precisely the film properties in respect, for example, of lubricity, abrasion resistance, water repellency, polishability, hand or gloss. This procedure is known from the field of printing inks and varnishes, textile processing, polish application, leather production and papermaking.

Such combinations, however, are always physical mixtures, which no longer achieve the base performance of the film. Attempts have already been made on numerous occasions to tailor properties directly through the incorporation of suitable monomers. Disclosures include combinations of ethylene and acrylic acid, or the grafting of nonpolar plastics with polar monomers. Resultant crystalline waxes of low molecular mass are, however, generally too hard and too brittle, and undergo flaking; noncrystalline, amorphous waxes have inadequate moduli to fulfill the required film properties for the majority of applications. The molar weights are also usually lower than the 50,000 g/mol needed for solid films to form. Another approach is the incorporation of hydrophobic acrylic acid derivatives such as lauryl acrylate or stearyl acrylate; however, the properties of the side chains are generally inadequate to incorporate the wax character into the film.

One approach at a solution to the chemical incorporation of waxes is described in DE 10 003 118. This approach, however, relates to the incorporation of particles into a film produced in situ. The solid waxes described in DE 10 003 118 are reaction products of polyhydric alcohols and montan wax acid, which have been subsequently esterified with acrylic acid such that wax particles produced from them are incorporated chemically into UV varnishes and hence are very difficult to extract from the film again.

The object was therefore to prepare polymers with sufficient molar weight for film strength, and with suitable monomer combination for the attainment of wax-typical properties.

It has now surprisingly been found that the known UV-curable wax derivatives, given appropriate formulation, can be used in emulsion polymerization and that the resultant emulsion polymers exhibit the requisite strength and the desired wax properties in the film.

This object is achieved in accordance with the invention by means of a copolymer of at least two monomers selected from the group containing:
A acrylic esters/methacrylic esters,
B ethylenically unsaturated acids such as acrylic acid, methacrylic acid, itaconic acid,
C styrene or styrene derivatives,
D di- and trifunctional ethylenically unsaturated compounds such as divinylbenzene, glycol diacrylate, TMP triacrylate,
E vinyl ethers,
F polymerizable waxes,
   component F being contained in the copolymer in an amount of at least 1% by weight.

The copolymer preferably contains the monomers of the individual components in the following amounts:
A esters in the range from 10% to 98% by weight,
B acids in the range from 0.5% to 5% by weight,
C styrene in the range from 0 to 90% by weight,
D di- and trifunctional compounds in the range from 0 to 5% by weight,
E vinyl ethers in the range from 0 to 20% by weight, and
F waxes in the range from 1 to 80% by weight, based in each case on the total weight of the copolymer.

The copolymers of the present invention are employed preferably in the form of an aqueous dispersion or, alternatively, in the form of a dried solid, or as a dried solid with custom-tailored particle size. The custom-tailored particle size is achieved preferably by agglomeration and subsequent drying or by drying and subsequent grinding, or by spray drying and subsequent classification.

The invention is described in greater detail by the examples which follow.

### EXAMPLE 1

Preparation Example for a Free-Radically Polymerizable Wax:

Reaction of a tetrahydric alcohol with a mixture of long-chain monocarboxylic acids and long-chain dicarboxylic acids (montan wax acid) to give a preliminary ester containing 2.3 mol of free OH groups, target product with one mole of acrylic ester.

Montan wax acid is melted, pentaerythritol and Sn catalyst are added at a temperature of 120° C., then heating is continued and esterification is carried out at 190° C. until an SN<10 is reached. The batch is cooled to a temperature of 120° C., methanesulfonic acid is added, acrylic acid is metered in, and esterification is carried out until an SN<10 is reached. Water of reaction and excess acrylic acid are removed by distillation.

The catalyst is neutralized, volatile constituents are distilled off under reduced pressure, and the product is filtered and processed.

Batch of Reactive Wax Compound

| | | | | | |
|---|---|---|---|---|---|
| Pentaerythritol | 1.00 | mol | SN | 13 | mg KOH |
| Montan wax acid | 2.00 | mol | VN | 172 | mg KOH |
| Acrylic acid | 1.10 | mol | Tp | 76 | ° C. |
| Sn catalyst | 0.15 | % by wt. | SV100 | 223 | mPa s |
| Methanesulfonic | 0.10 | % by wt. | | | |
| acid | | | | | |

In all compounds it is possible to confirm the incorporation of the acrylic acid by means of 13-C-NMR and IR.

### EXAMPLE 2

Preparation Example for a Reactive Wax Emulsion

Melting of reactive wax Licomont ER 165 at a temperature<120° C. with slow stirring.

The melt is then combined with the water/emulsifier mixture at 90° C. and the resulting emulsion is cooled rapidly. The solids of the dispersion is approximately 25%, the polymerizable wax content 20%.

Reactive Wax Emulsion

| Components | Unit | Amount |
|---|---|---|
| Licomont ER 165 | g | 20.48 |
| Emulsifier mixture | g | 4.27 |
| KOH 43% strength | g | 0.85 |
| DI water | g | 74.3 |
| Preservative | g | 0.1 |
| Dispersion | g | 100 |

### EXAMPLE 3

Preparation Example for an Inventive Wax Copolymer Dispersion with an MFT of 32

Water, emulsifier, and a portion of monomer 1 are introduced as an initial charge and heated to 75° C. Ammonium peroxodisulfate is dissolved in DI water and added. After the start of the reaction the batch is heated to 80° C. and the remainder of monomer 1, monomer 2, and the reactive wax dispersion from Example 2 are metered in. The batch is stirred until the monomers have undergone full reaction and then is cooled and stabilized with redox agent and preservative, and the pH is adjusted.

For applications in acidic formulations the dispersion can be left at a pH of 6; for applications in neutral or basic formulations the pH can be adjusted to 7 to 8 by addition of aqueous ammonia.

Following pH adjustment the dispersion is filtered through a fine gauze filter.

Batch of Acrylate Wax Copolymer with an MFT of 32

| Substance | Amount |
|---|---|
| Dispersion from Example 2 | 450 |
| Emulsifier 28% form | 52.89 |
| Monomer 1 | 70.1 |
| Monomer 2 | 397.8 |
| Ammonium peroxodisulfate | 1.5 |
| DI water | 1019.36 |
| Ascorbic acid | 1.4 |
| H₂O₂ 30% strength | 6.95 |
| Ammonia 25% strength | |
| Saniprot 94-08 | 0.6 |

| | |
|---|---|
| Viscosity: | 150 cps, |
| Solids: | approximately 30%, |
| Transparency: | approximately 55% in 1% dilution, |
| Density: | approximately 1.03 kg/l |
| MFT: | approximately 32 |

Monomer 1 and monomer 2 are mixtures of

| | | |
|---|---|---|
| methyl methacrylate | MMA | 230.5 |
| ethyl acrylate | EA | 233.9 |
| methacrylic acid | MAA | 3.5 |

### EXAMPLE 4

Preparation Example for a Wax Copolymer Dispersion with an MFT of 16

Water, emulsifier, and a portion of monomer 1 are introduced as an initial charge and heated to 75° C. Ammonium peroxodisulfate is dissolved in DI water and added. After the start of the reaction the batch is heated to 80° C. and the remainder of monomer 1, monomer 2, and the reactive wax dispersion from Example 2 are metered in. The batch is stirred until the monomers have undergone full reaction and then is cooled and stabilized with redox agent and preservative, and the pH is adjusted.

For applications in acidic formulations the dispersion can be left at a pH of 6; for applications in neutral or basic formulations the pH can be adjusted to 7 to 8 by addition of aqueous ammonia.

Following pH adjustment the dispersion is filtered through a fine gauze filter.

Batch of acrylate wax copolymer with an MFT of 16

| Substance | Amount |
|---|---|
| Dispersion from Example 2 | 450 |
| Emulsifier 28% form | 52.89 |
| Monomer 1 | 70.1 |
| Monomer 2 | 397.8 |
| Ammonium peroxodisulfate | 1.5 |
| DI water | 1019.36 |
| Ascorbic acid | 1.4 |
| H₂O₂ 30% strength | 6.95 |
| Ammonia 25% strength | |
| Saniprot 94-08 | 0.6 |

| | |
|---|---|
| Viscosity: | 150 cps, |
| Solids: | approximately 30%, |
| Transparency: | approximately 55% in 1% form, |
| Density: | approximately 1.03 kg/l |
| MFT: | approximately 16 |

Monomer 1 and monomer 2 are mixtures of

| | | |
|---|---|---|
| methyl methacrylate | MMA | 207 |
| ethyl acrylate | EA | 257.4 |
| methacrylic acid | MAA | 3.5 |

### EXAMPLE 5

Preparation Example for a Styrene/Acrylate Wax Copolymer with an MFT of 32

Water, emulsifier, and a portion of monomer 1 are introduced as an initial charge and heated to 75° C. Ammonium peroxodisulfate is dissolved in DI water and added. After the start of the reaction the batch is heated to 80° C. and the remainder of monomer 1, monomer 2, and the reactive wax dispersion from Example 2 are metered in. The batch is stirred until the monomers have undergone full reaction and then is cooled and stabilized with redox agent and preservative, and the pH is adjusted to 7 to 8 by addition of aqueous ammonia.

Following pH adjustment the dispersion is filtered through a fine gauze filter.

Batch of Styrene/Acrylate Wax Copolymer with an MFT of 32

| Substance | Amount |
|---|---|
| Reactive wax dispersion | 450 |
| Dispersogen LFES | 52.89 |
| Monomer 1 | 70.1 |
| Monomer 2 | 397.8 |
| Ammonium peroxodisulfate | 1.5 |
| DI water | 1019.36 |
| Ascorbic acid | 1.4 |
| H₂O₂ 30% strength | 6.95 |
| Ammonia 25% strength | |
| Saniprot 94-08 | 0.6 |

| | |
|---|---|
| Viscosity: | 150 cps, |
| Solids: | approximately 30%, |
| Transparency: | approximately 55% in 1% dilution, |
| Density: | approximately 1.03 kg/l |
| MFT: | approximately 32 |

| | | |
|---|---|---|
| Styrene | Styrene | 99.4 |
| methyl methacrylate | MMA | 124.5 |
| ethyl acrylate | EA | 257.5 |
| methacrylic acid | MAA | 3.5 |

### EXAMPLE 6

Preparation Example for a Wax Copolymer Dispersion Core/Shell with an MFT of 32 and Crosslinked Core

Water, emulsifier, and a portion of monomer 1 are introduced as an initial charge and heated to 75° C. Ammonium peroxodisulfate is dissolved in DI water and added. After the start of the reaction the batch is heated to 80° C. and the remainder of monomer 1, monomer 2, and the reactive wax dispersion from Example 2 are metered in. The batch is stirred until the monomers have undergone full reaction and then is cooled and stabilized with redox agent and preservative, and the pH is adjusted to 7 to 8 by addition of aqueous ammonia.

Following pH Adjustment the Dispersion is Filtered Through a Fine Gauze Filter.

| Batch for Example 6 | Amount |
|---|---|
| Dispersion from Example 2 | 450 |
| Emulsifier | 52.89 |
| Monomer 1 | 70.1 |
| Monomer 2 | 397.8 |
| Ammonium peroxodisulfate | 1.5 |
| DI water | 1019.36 |
| Ascorbic acid | 1.4 |
| H₂O₂ 30% strength | 6.95 |
| Ammonia 25% strength | |
| Saniprot 94-08 | 0.6 |

| | |
|---|---|
| Viscosity: | 150 cps, |
| Solids: | approximately 30%, |
| Transparency: | approximately 55% in 1% form, |
| Density: | approximately 1.03 kg/l |
| MFT: | approximately 18 |

| | | |
|---|---|---|
| methyl methacrylate | MMA | 121.1 |
| ethyl acrylate | EA | 257.5 |
| methacrylic acid | MAA | 3.5 |
| Styrene | Styrene | 81.9 |

### EXAMPLE 7

Preparation Example for a Colored Reactive Wax Dispersion

Reactive wax Licomont ER 165 is melted at a temperature<120° C. with slow stirring. The dye is added to the melt and dispersed homogeneously. The melt is then combined with the water/emulsifier mixture at 90° C. and the resulting emulsion is cooled rapidly. The solids of the dispersion is approximately 25%, the polymerizable wax content 20%. The wax dispersion colored in this way is used as a reactive component in the polymerization.

Colored Reactive Wax Emulsion

| Components | Unit | Amount |
|---|---|---|
| Licomont ER 165 | g | 20.48 |
| Emulsifier mixture | g | 4.27 |
| KOH 43% strength | g | 0.85 |
| DI water | g | 74.3 |
| Polysynthren Red FBL | | |
| Preservative | g | 0.1 |

### EXAMPLE 8

Colored Wax Copolymer Dispersions

Water, emulsifier, and a portion of monomer 1 are introduced as an initial charge and heated to 75° C. Ammonium peroxodisulfate is dissolved in DI water and added. After the start of the reaction the batch is heated to 80° C. and the remainder of monomer 1, monomer 2, and the dyed reactive wax dispersion from Example 7 are metered in. The batch is stirred until the monomers have undergone full reaction and then is cooled and stabilized with redox agent and preservative, and the pH is adjusted to 7 to 8 by addition of aqueous ammonia.

Following pH adjustment the dispersion is filtered through a fine gauze filter.

Batch for Acrylate Wax Copolymer with an MFT of 16

| Substance | Amount |
|---|---|
| Dispersion from Example 7 | 450 |
| Emulsifier 28% form | 52.89 |
| Monomer 1 | 70.1 |
| Monomer 2 | 397.8 |
| Ammonium peroxodisulfate | 1.5 |
| DI water | 1019.36 |
| Ascorbic acid | 1.4 |
| H₂O₂ 30% strength | 6.95 |
| Ammonia 25% strength | |
| Saniprot 94-08 | 0.6 |

| | |
|---|---|
| Viscosity: | 150 cps, |
| Solids: | approximately 30%, |
| Transparency: | approximately 55% in 1% form, |
| Density: | approximately 1.03 kg/l |
| MFT: | approximately 16 |

Monomer 1 and monomer 2 are mixtures of

| | | |
|---|---|---|
| methyl methacrylate | MMA | 207 |
| ethyl acrylate | EA | 257.4 |
| methacrylic acid | MAA | 3.5 |

From dispersions prepared in this way it is possible appropriately, by spray drying, to produce granules which can be employed as wax or as a binder component in colored toners.

### APPLICATIONS

The wax copolymer dispersions of the invention can be used as base materials for producing coatings. Formulations of this kind include the typical additives such as wetting agents, defoamers, film-forming assistants, viscosity regulators, etc.

They can be used alone or in combination with commercially customary binder systems such as acrylate dispersions, styrene/acrylates or PU dispersions.

The formulations can be used as clearcoating materials or, with colorant added, as colored coating materials. Coatings comprising the wax copolymer dispersions of the invention are notable for a short drying time, satin gloss, and waxlike hand.

Application Example: Wood Varnish

Aqueous varnish formulation:

| | |
|---|---|
| Mowilith LDM7460 | 35.00 |
| Dispersion from Example 4 | 40.00 |
| Water | 5.00 |
| Water | 1.00 |
| Saniprot 99-73 | 0.20 |
| Propane-1,2-diol | 1.00 |
| AMP90 | 0.20 |
| BYK 348 | 0.50 |
| Texanol | 1.00 |
| Agitan 295 | 0.20 |
| Water | 11.10 |
| Tafigel PUR 40 | 0.30 |
| Methoxybutanol | 2.50 |

The wax copolymer dispersions of the invention can also be dried. The residue from drying can then be ground and employed as a toner wax or as an additive in dispersions, as an antiblocking agent, matting agent, slip additive, etc.

1. A copolymer of at least two monomers selected from the group consisting of:
A acrylic esters or methacrylic esters,
B ethylenically unsaturated acids,
C styrene or styrene derivatives,
D di- or trifunctional ethylenically unsaturated compounds,
E vinyl ethers,
F polymerizable waxes,
component F being necessarily contained in the copolymer in an amount of at least 1% by weight.

2. The copolymer as claimed in claim 1, containing monomers in the following amounts:
A the acrylic esters or methacrylic esters in the range from 10% to 98% by weight,
B the ethylenically unsaturated acids in the range from 0.5% to 5% by weight,
C the styrene or styrene derivatives in the range from 0 to 90% by weight,
D the di- or trifunctional ethylenically unsaturated compounds in the range from 0 to 5% by weight,
E the vinyl ethers in the range from 0 to 20% by weight, and
F the polymerizable waxes in the range from 1 to 80% by weight,
based in each case on the total weight of the copolymer.

3. The copolymer as claimed in claim 1, wherein the copolymer is in the form of an aqueous dispersion, a dried solid, or a dried solid with custom-tailored particle size.

4. A process for preparing copolymer as claimed in claim 1, comprising the steps of emulsifying the at least two monomers are subjecting the at least two monomers to free-radical polymerization to form the copolymer.

5. The process as claimed in claim 4, further comprising the step of sizing the copolymer by agglomeration and drying, by drying and grinding, or by spray drying and classification.

6. A coating composition for coating paper, wood, floors, seed or autocare comprising a copolymer according to claim 1.

7. A binder for inks, printing inks, varnishes or seed comprising a copolymer according to claim 1.

8. A particle coating comprising a copolymer according to claim 1.

9. A matting agent in varnishes comprising a copolymer according to claim 1.

10. A toner wax comprising a copolymer according to claim 1.

11. The copolymer as claimed in claim 1, wherein the ethylenically unsaturated acids are selected from the group consisting of acrylic acid, methacrylic acid and itaconic acid.

12. The copolymer as claimed in claim 1, wherein the di- and trifunctional ethylenically unsaturated compounds are selected from the group consisting of divinylbenzene, glycol diacrylate and TMP triacrylate.
